(19) United States
(12) Patent Application Publication
(10) Pub. No.: US 2005/0106001 A1
(43) Pub. Date: May 19, 2005

(54) Forkliftable cold storage

(76) Inventor: Anthony D'Andrea, Cooper City, FL (US)

Correspondence Address: Mr. Walter J. Tencza Jr., Suite 3, 10 Station Palce, Metuchen, NJ, 08840, US

(21) Appl. No.: 10/717,280

(22) Filed: Nov. 19, 2003

(51) Int. Cl. B66F 1/00

(52) U.S. Cl. 414/814

(57) ABSTRACT

An apparatus including a base having first and second slots and a cold storage unit placed on top of the base is disclosed. A first prong of a forklift can be inserted into the first slot and a second prong of the forklift can be inserted into the second slot and the forklift can use the first and second prongs to lift up the base and the cold storage unit. The base may have third and fourth slots. The first prong can be inserted into the third slot and the second prong can be inserted into the fourth slot in order to lift up the base and the cold storage unit. The first and second slots may be substantially perpendicular to the third and fourth slots.

### FIELD OF THE INVENTION

This invention relates to cold storage methods and apparatus.

### BACKGROUND OF THE INVENTION

Typically in the prior art large refrigeration units and other devices designed for cold storage are very large and difficult to move.

### SUMMARY OF THE INVENTION

The present invention in one or more embodiments provides an apparatus comprising a base having first and second slots and a cold storage unit placed on top of the base. A first prong of a forklift can be inserted into the first slot and a second prong can be inserted into the second slot and the forklift can use the first and second prongs to lift up the base and the cold storage unit.

The base may have third and fourth slots. The first prong can be inserted into the third slot and the second prong can be inserted into the fourth slot. With the first prong inserted into the third slot and the second prong inserted into the fourth slot, the forklift can lift up the base and the cold storage unit. The first and the second slots may be substantially perpendicular to the third and the fourth slots. A method is also provided comprising the steps of placing a cold storage unit on top of a base, and inserting a first prong of a forklift into a first slot of a base and a second prong of the forklift into a second slot of the base. With the first prong in the first slot and the second prong in the second slot, the forklift can be used to lift up the base and the cold storage unit.

The method may also include inserting the first prong of the forklift into a third slot of the base and the second prong of the forklift into a fourth slot of the base. The first and second slots may be substantially perpendicular to the third and the fourth slots. With the first prong in the third slot and the second prong in the fourth slot, the forklift may be used to lift up the base and the cold storage unit.

### BRIEF DESCRIPTION OF THE DRAWINGS

FIG. 1 shows a perspective view of a forkliftable base in accordance with an embodiment of the present invention;

FIG. 2 shows a front perspective view of a refrigeration unit attached to the forkliftable base of FIG. 1;

FIG. 3 shows a rear perspective view of the refrigeration unit of FIG. 2 attached to the forkliftable base of FIG. 1;

FIG. 4 shows a front view of the refrigeration unit of FIG. 2 attached to the forkliftable base of FIG. 1;

FIG. 5A shows a first pair of locations where prongs of a forklift could be inserted into the base of FIG. 1; and

FIG. 5B shows a second pair of locations where prongs of a forklift could be inserted into the base of FIG. 1.

### DETAILED DESCRIPTION OF THE DRAWINGS

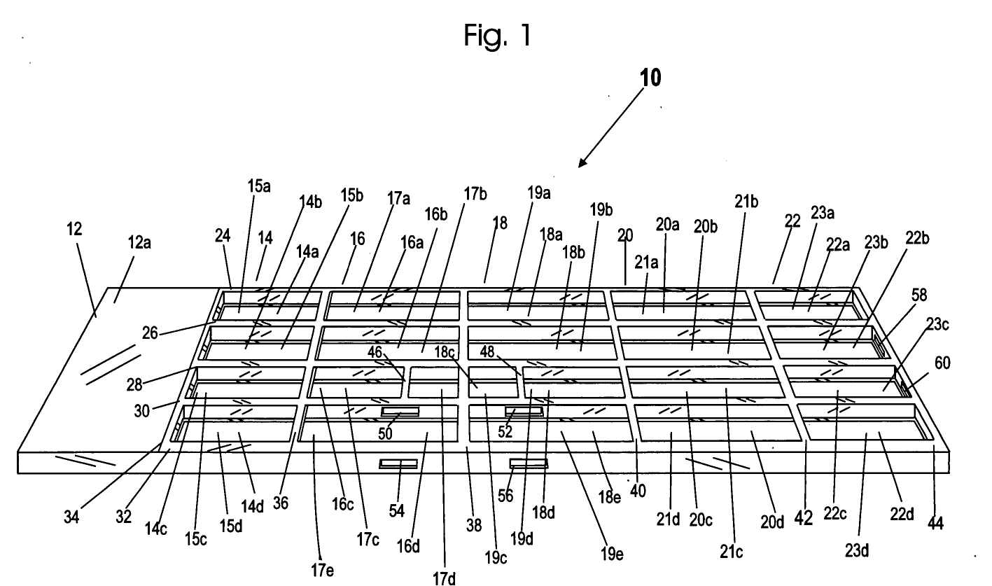

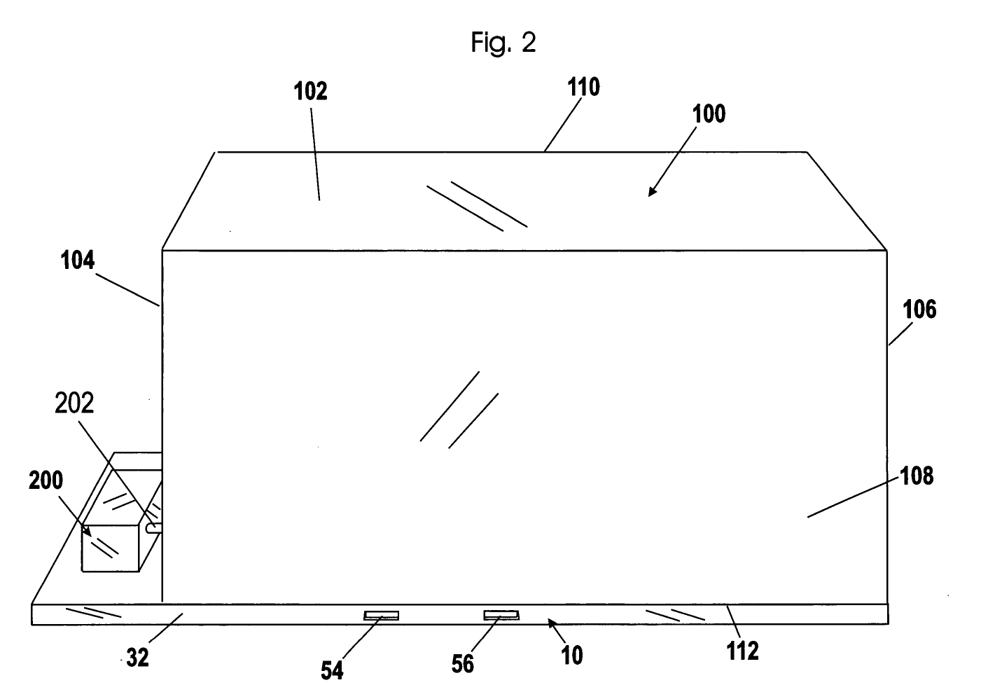

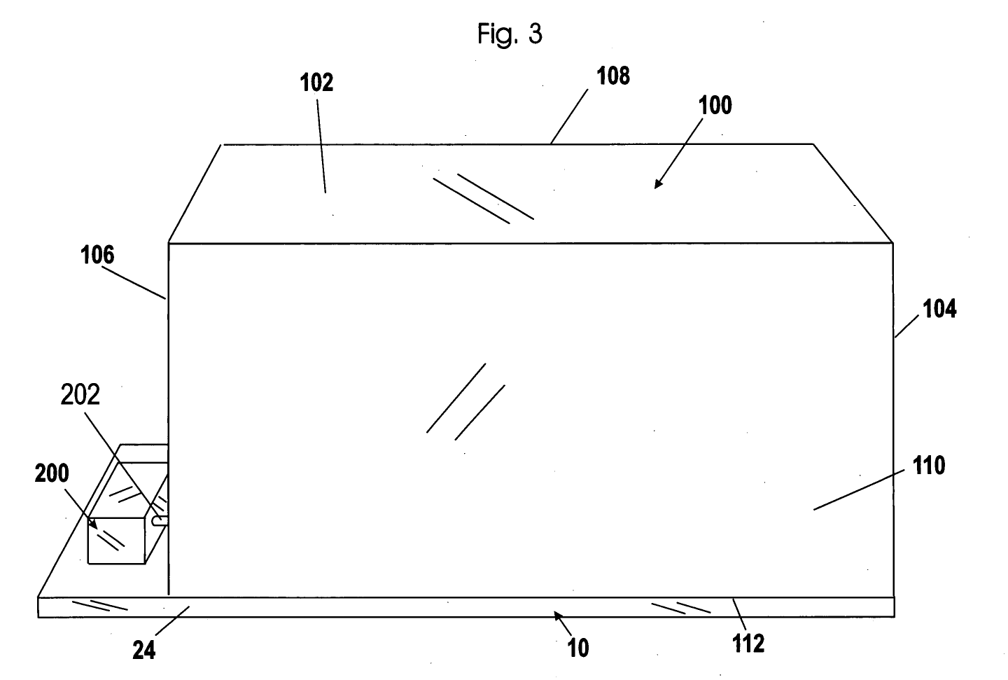

FIG. 1 shows a perspective view of a forkliftable base 10 in accordance with an embodiment of the present invention. The base 10 includes sections 12, 14, 16, 18, 20, and 22. Section 12 may have a flat plate or surface 12a, for supporting a fastened down condensing unit, such as unit 200 shown in FIGS. 2 and 3. The base 10 may include row members 24, 26, 28, 30, and 32, and column members 34, 36, 38, 40, 42, and 44. The row and column members form grid sections. The base 10 may also include members 46 and 48.

Section 14 includes grid sections 15a, 15b, 15c, and 15d. Each grid section surrounds an opening. Grid sections 15a-d surround openings 14a-d, respectively. Similarly, section 16 includes grid sections 17a, 17b, 17c, and 17d. Grid sections 17a-d surround openings 16a-16d, respectively. Similarly, section 18 includes grid sections 19a, 19b, 19c, and 19d. Grid sections 19a-d surround openings 18a-18d, respectively. Similarly section 20 includes grid sections 21a, 21b, 21c, and 21d. Grid sections 21a-d surround openings 20a-20d respectively. Similarly section 22 includes grid sections 23a, 23b, 23c, and 23d. Grid sections 23a-d surround openings 22a-22d respectively. The base 10 also includes slots 50 and 52 in row member 30, slots 54 and 56 in row member 32, and slots 58 and 60 in column member 44.

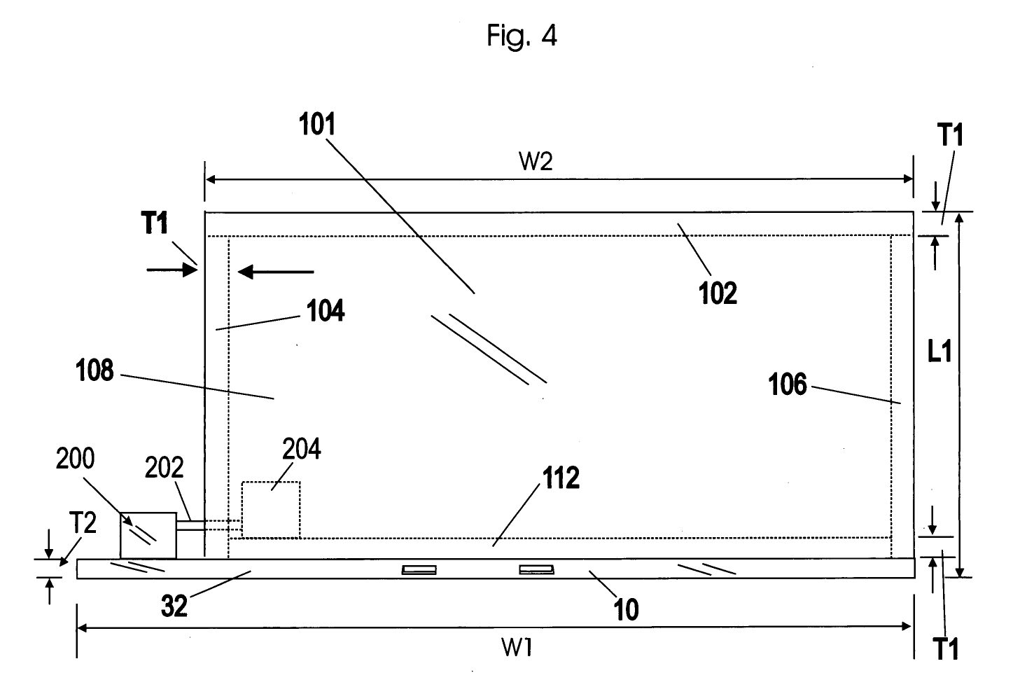

FIG. 2 shows a front perspective view of a refrigeration unit 100 attached to the forkliftable base 10 of FIG. 1. FIG. 3 shows a rear perspective view of the refrigeration unit 100 attached to the forkliftable base 10 of FIG. 1. FIG. 4 shows a front view of the refrigeration unit 100 attached to the forkliftable base 10.

The refrigeration or cold storage unit 100 may include a top 102, sides 104 and 106, a front 108, a back 110, and a bottom 112. Each of the top 102, sides 104 and 106, front 108, back 110, and bottom 112 may be insulated panels or any cold storage wall construction. In FIG. 3, dashed lines are used to show the thicknesses. As shown by FIG. 4, the top 102 may be a plate having a thickness T1, which may be four inches. The sides 104 and 106 may also each have a thickness of TI, which may be four inches. The front 108, back 110 and the bottom 112 may also each have a thickness of T1, which may be four inches. The length, L1, from the top of the top 102 to the bottom of base 10 may be eight feet. The width, W1, of the forkliftable base 10, may be fourteen feet. The width, W2 of the top 102 may be ten feet.

FIGS. 2, 3, and 4 also show a mechanical system 200, such as a condensing unit for generating cold air which can be supplied to the cold storage unit 100, through piping 202 to an evaporator 204, which can be mounted inside the cold storage unit 100. The cold storage unit 100 may be boxed shaped with a cavity or chamber 101 within the box shape, which can be entirely sealed by the top 102, sides 104, 106, front 108, back 110, and the bottom 112. There may be a door, located for example in the front 108 which can be closed to seal chamber 101 inside the cold storage unit 100. The front 108 itself may be a door. The method of generating cold air for the cold storage unit 100 may be that used for a typical known refrigeration apparatus.

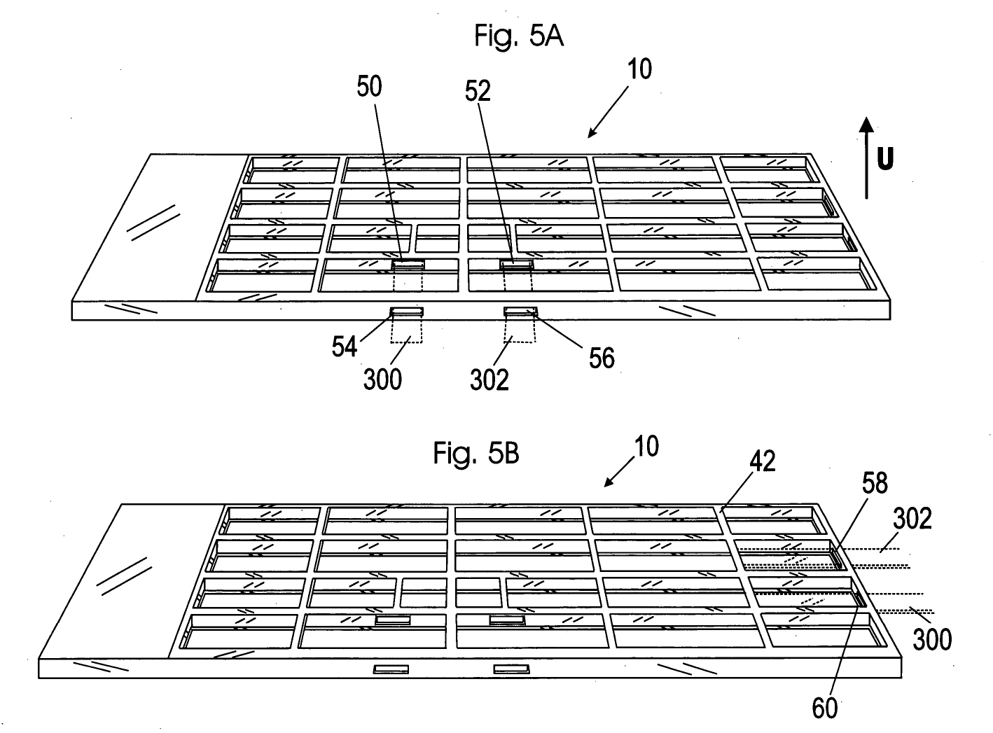

FIG. 5A shows a first pair of locations where prongs 300 and 302 of a forklift could be inserted into the base 10 of FIG. 1. In FIG. 5A, prong 300, shown by dashed lines is inserted into slot 54 and slot 50. Prong 302, shown by dashed lines, is inserted into slot 56 and slot 52. The base 10 can be lifted upwards in the direction U, by a forklift having prongs 300 and 302. The forklift when lifting up base 10, can also lift up any cold storage unit, such as unit 100, and any system such as system 200, which may be located on or fixed on top of the base 10.

FIG. 5B shows a second pair of locations where the prongs 300 and 302 of the forklift could be inserted into the base 10 of FIG. 1. In FIG. 5B, prong 300, shown by dashed lines is inserted into slot 58 and the prong 300 may be inserted to be under column member 42. Prong 302, shown by dashed lines, is inserted into slot 60 and the prong 302 may be inserted to be under column member 42. The base 10 can be lifted upwards in the direction U, by a forklift having prongs 300 and 302. The forklift when lifting up base 10, can also lift up any cold storage unit, such as unit 100, and any system such as system 200, which may be located on or fixed on top of the base 10.

Note that to lift and move the base 10 and unit 100 only one pair of either slots 54 and 56 or slots 58 and 60 can be provided. However having two sets of slots, allows a forklift operator an option to choose which slots are most convenient.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a base having first and second slots;
a cold storage unit placed on top of the base;
wherein a first prong of a forklift can be inserted into the first slot and a second prong can be inserted into the second slot;
and wherein with the first prong inserted into the first slot and the second prong inserted into the second slot, the forklift can lift up the base and the cold storage unit.

2. The apparatus of claim 1 wherein
wherein the base has third and fourth slots;
wherein the first prong can be inserted into the third slot and the second prong can be inserted into the fourth slot;
and wherein with the first prong inserted into the third slot and the second prong inserted into the fourth slot, the forklift can lift up the base and the cold storage unit.

3. The apparatus of claim 2 wherein
the first and the second slots are substantially perpendicular to the third and the fourth slots.

4. A method comprising the steps of:
placing a cold storage unit on top of a base;
inserting a first prong of a forklift into a first slot of a base and a second prong of the forklift into a second slot of the base; and
with the first prong in the first slot and the second prong in the second slot using the forklift to lift up the base and the cold storage unit.

5. The method of claim 4 wherein
inserting the first prong of the forklift into a third slot of the base and the second prong of the forklift into a fourth slot of the base;
wherein the first and second slots are substantially perpendicular to the third and the fourth slots; and
with the first prong in the third slot and the second prong in the fourth slot using the forklift to lift up the base and the cold storage unit.
